(19) United States
(12) Patent Application Publication
(10) Pub. No.: US 2018/0006408 A1
(43) Pub. Date: Jan. 4, 2018

(54) ELECTRICAL CONNECTOR HAVING IMPROVED CONDUCTIVE TERMINALS

(71) Applicant: FOXCONN INTERCONNECT TECHNOLOGY LIMITED, Grand Cayman (KY)

(72) Inventors: WEI WEN, HUAIAN (CN); JUN ZHAO, HUAIAN (CN); JIN-GUO QIU, HUAIAN (CN)

(21) Appl. No.: 15/638,402

(22) Filed: Jun. 30, 2017

(30) Foreign Application Priority Data
Jun. 30, 2016 (CN) 201610497327.3

(51) Int. Cl. H01R 13/6581; H01R 24/62; H01R 13/6594; H01R 13/6585; H01R 107/00; H01R 12/72

(52) U.S. Cl. CPC H01R 13/6581; H01R 13/6594; H01R 13/6585; H01R 24/62; H01R 12/721; H01R 2107/00

(57) ABSTRACT

An electrical connector includes: a terminal module comprising an insulative housing having a base portion and a tongue portion, an upper and a lower rows of conductive terminals, and a metallic shielding plate clamped between the two rows of conductive terminals; each row of conductive terminals including plural grounding terminals located on both sides of the tongue portion, and plural power terminals located on the inside of the grounding terminals; each conductive terminal having a contacting section, a tail section, and a retaining section; wherein an upper power terminal and a corresponding lower power terminal are an integral block structure and extending along a thickness direction of the tongue portion in the tongue portion, a thickness of the contacting section of each power terminal is at least twice the thickness of the contacting section of each grounding terminal.

### BACKGROUND OF THE INVENTION

### 1. Field of the Invention

The present invention relates to an electrical connector, and more particularly to an electrical connector adapted for being normally and reversely mated with a complementary connector.

### 2. Description of Related Art

China Patent No. 204696302, issued on Oct. 7, 2015, discloses an electrical connector adapted for being normally and reversely mated with a complementary connector. The electrical connector has an insulative housing provided with a tongue portion, an upper row of terminals, a lower row of terminals, and a metallic plate provided with a pair of thickening portions. The thickening portions cover the both sides of the tongue portion and are adapted to be a plurality of grounding terminals. China Patent No. 205122849, issued on Mar. 30, 2016, discloses another electrical connector adapted for being normally and reversely mated with a complementary connector. The electrical connector has an insulative housing provided with a tongue portion, an upper and lower rows of terminals retained in the insulative housing. In one embodiment, a power terminal is of an integral block structure shared by or common to both the upper and lower rows. A vertical dimension of the common power terminal is equal to or greater than a thickness of the tongue portion.

An electrical connector having a power terminal formed into a block structure and a metallic shielding plate clamped between the grounding terminals of the two rows of conductive terminals is desired.

### SUMMARY OF THE INVENTION

An electrical connector comprises: a terminal module comprising an insulative housing provided with a base portion and a tongue portion, an upper row of conductive terminals and a lower row of conductive terminals retained to the insulative housing, and a metallic shielding plate clamped between the upper and lower rows of conductive terminals; each row of conductive terminals comprising a plurality of grounding terminals located on both sides of the tongue portion along a transverse direction, and a plurality of power terminals located on the inside of the grounding terminals; each conductive terminal having a contacting section exposed to a surface of the tongue portion, a tail section, and a retaining section connecting the contacting section and the tail section; wherein an upper power terminal and a corresponding lower power terminal are an integral block structure and extending along a thickness direction of the tongue portion in the tongue portion, a thickness of the contacting section of each power terminal is at least twice the thickness of the contacting section of each grounding terminal.

Other novel features of the invention will become more apparent from the following detailed description when taken in conjunction with the accompanying drawings.

### BRIEF DESCRIPTION OF THE DRAWINGS

FIG. 1 is an assembled perspective view of the electrical connector of a preferred embodiment of the instant invention;

FIG. 2 is an assembled perspective view of FIG. 1 seen from another direction;

FIG. 3 is a partially exploded perspective view of the separation of a sealer by the electrical connector of FIG. 2 of a preferred embodiment of the instant invention;

FIG. 4 is a partially exploded perspective view of the separation of a sealer, a metallic shell, and a terminal module by the electrical connector of a preferred embodiment of the instant invention;

FIG. 5 is a partially exploded perspective view of FIG. 4 seen from another direction;

FIG. 6 is a partially exploded perspective view of a terminal module of FIG. 5;

FIG. 7 is a partially exploded perspective view of FIG. 6 seen from another direction;

FIG. 8 is an exploded perspective view of a terminal module of a preferred embodiment of the instant invention;

FIG. 9 is an exploded perspective view of FIG. 8 seen from another direction;

FIG. 10 is an assembled perspective view of conductive terminals and a metallic shielding plate of a preferred embodiment of the instant invention; and

FIG. 11 is a cross-sectional view of the electrical connector of a preferred embodiment of the instant invention taken along line 11-11 of FIG. 1; FIG. 11(A) is a partially enlarged cross-sectional view of the electrical connector of another embodiment showing the cross-section of the contacting section of the power terminal somewhat different from that in FIG. 11.

### DETAILED DESCRIPTION OF THE PREFERRED EMBODIMENT

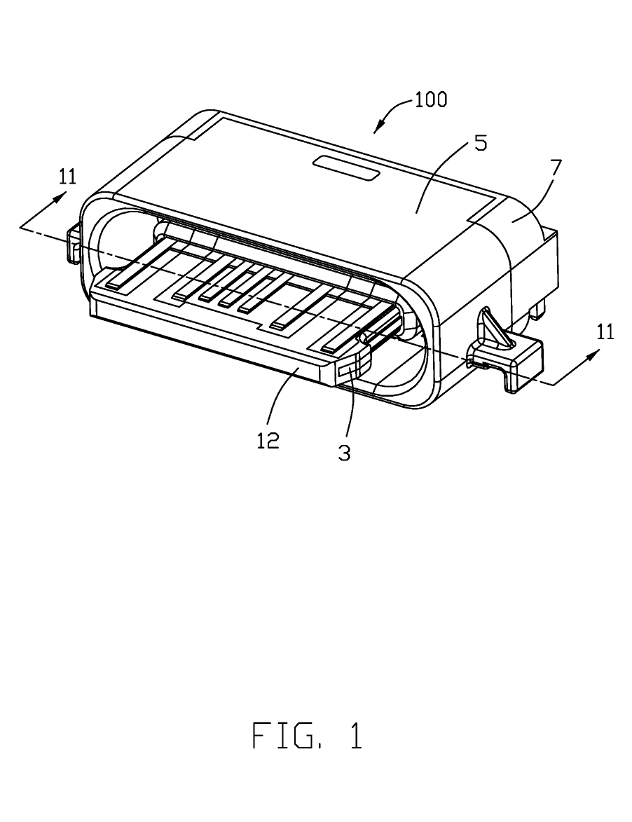

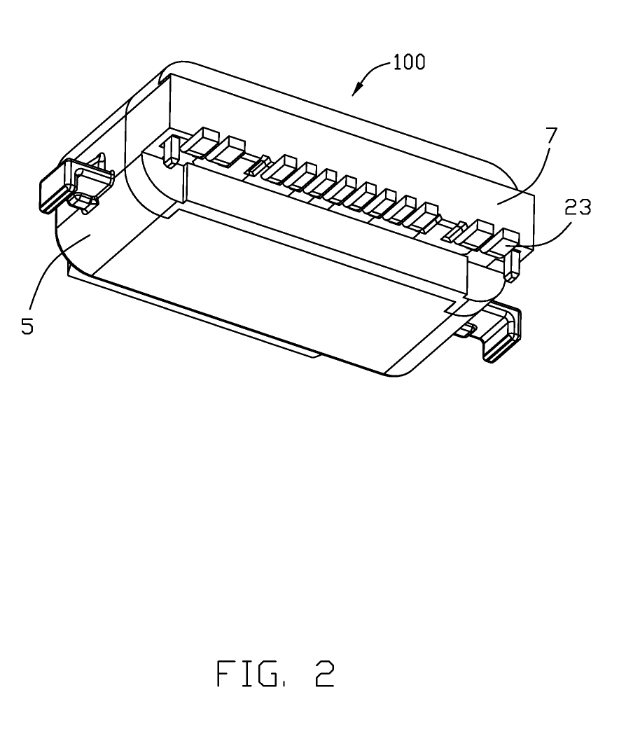

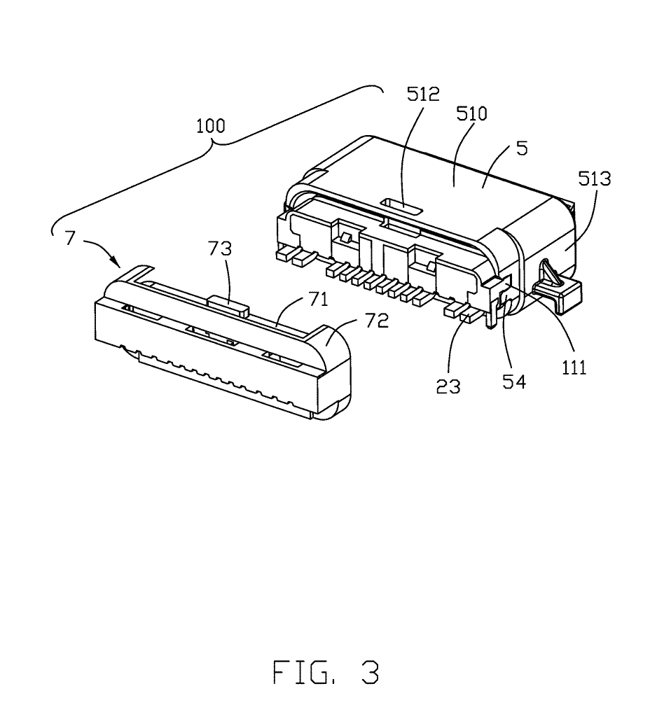

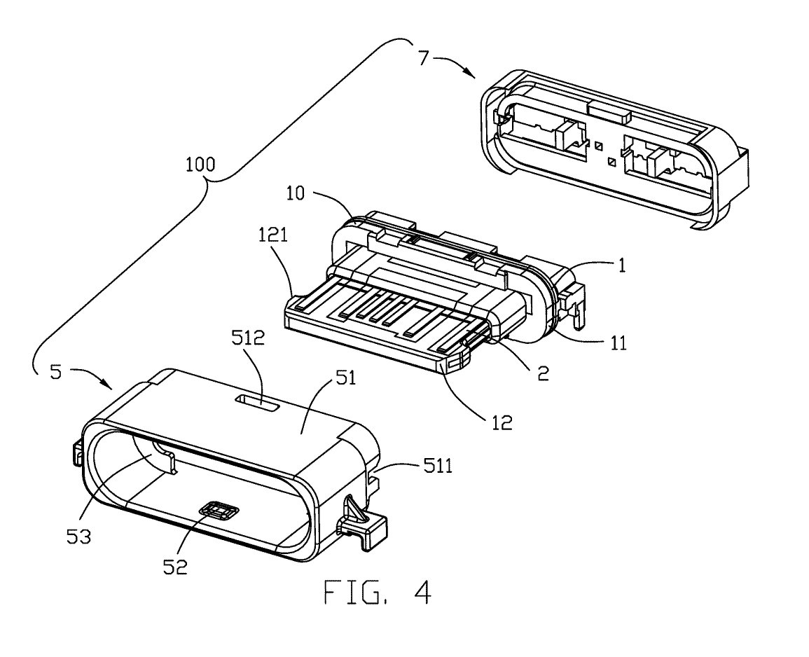

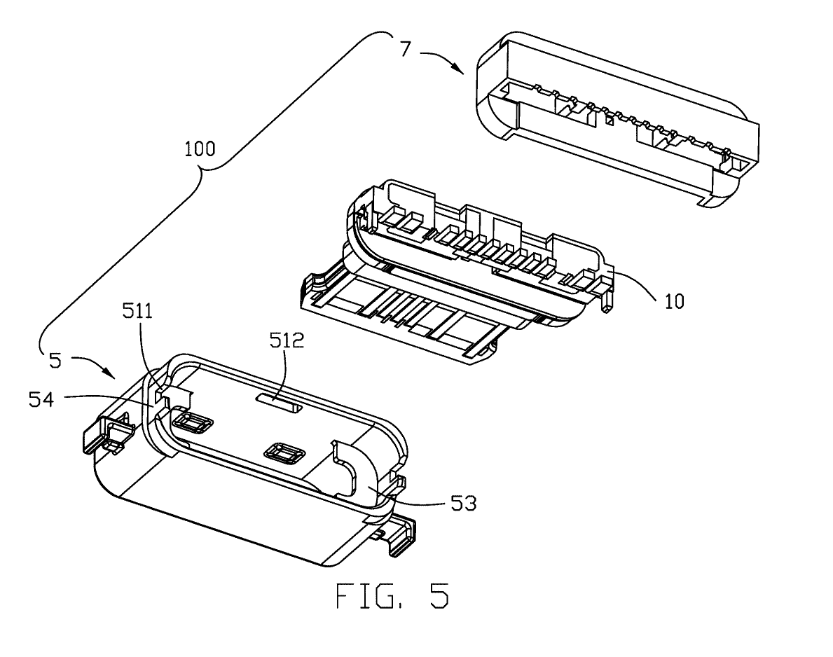

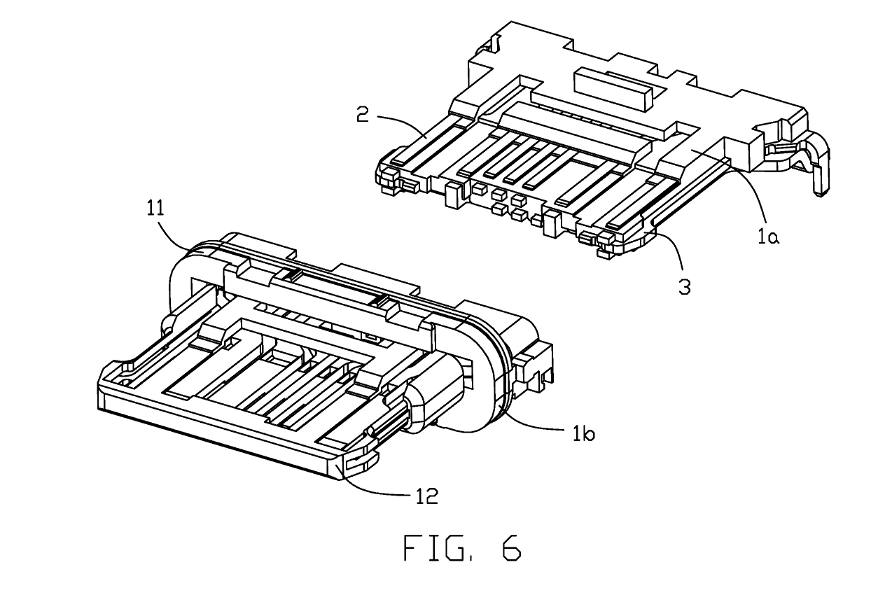

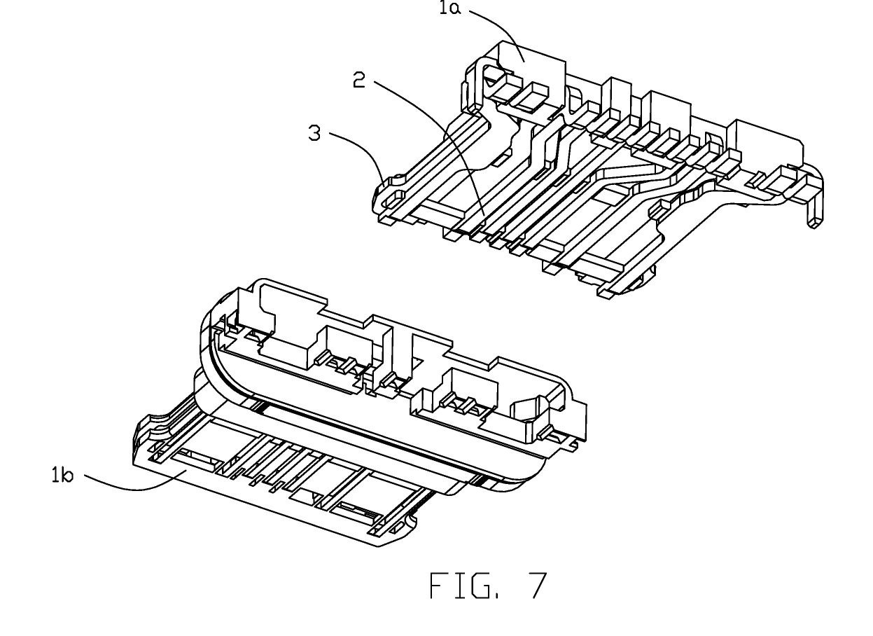

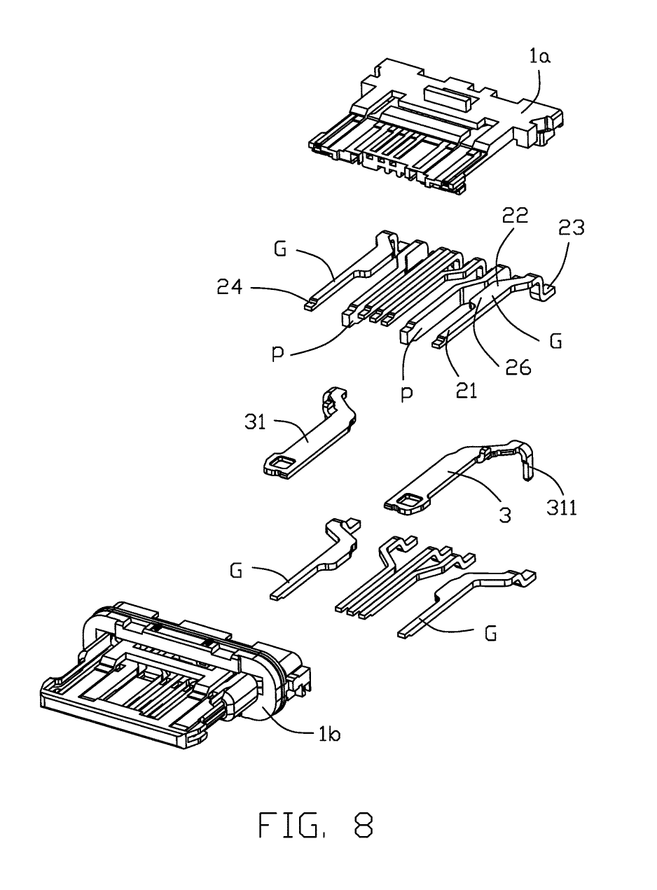

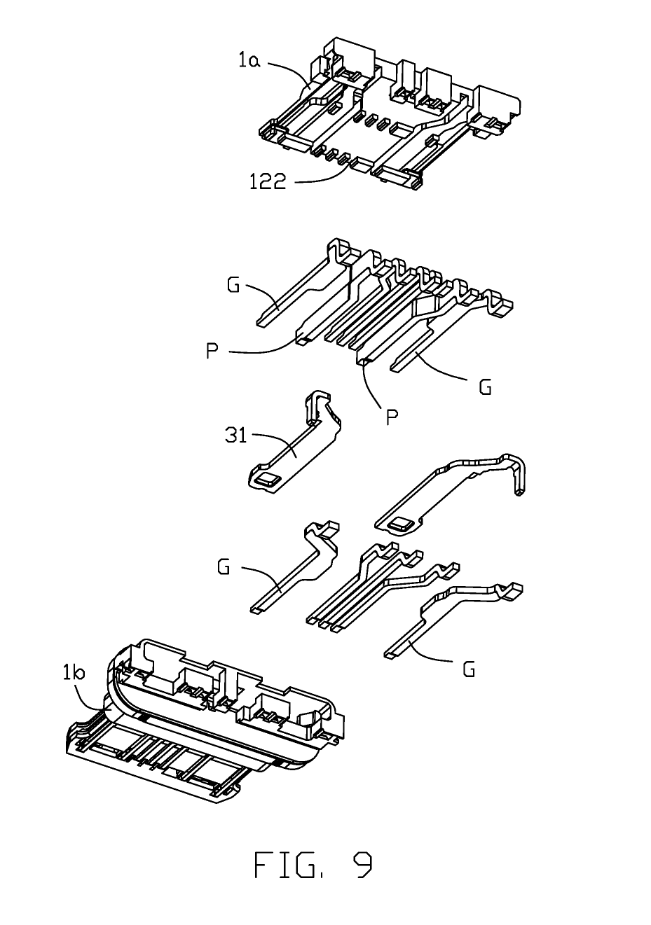

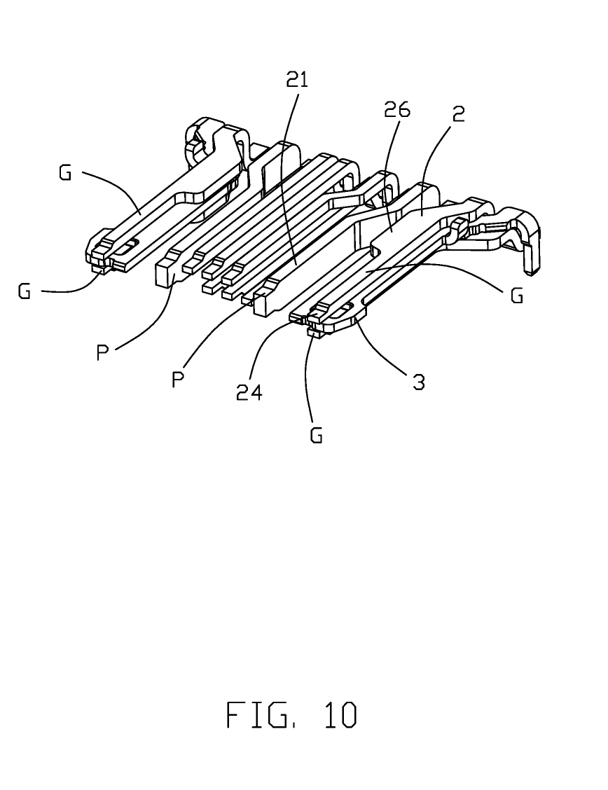

Reference will now be made in detail to the preferred embodiment of the present invention shown in FIGS. 1 to 11.

The electrical connector 100 has an insertion opening (not labeled) to mate a complementary plug connector (not shown). The electrical connector 100 has a front-to-rear direction, a transverse direction perpendicular to the front-to-rear direction, and a thickness direction (vertical direction) perpendicular to both the front-to-rear direction and the transverse direction, respectively. The electrical connector 100 defines the insertion opening at the front end thereof.

The electrical connector 100 of a preferred embodiment of the instant invention is a receptacle connector. The electrical connector 100 includes a terminal module 10, a metallic shell 5 assembled to an outside of terminal module 10, and a sealer 7.

The terminal module 10 includes an insulative housing 1 provided with a base portion 11 and a tongue portion 12, an upper row of conductive terminals 2 and a lower row of conductive terminals 2 retained to the insulative housing 1, and a metallic shielding plate 3 clamped between the upper and lower rows of conductive terminals 2. The two rows of conductive terminals 2 include a plurality of common terminals (not labeled) and are diagonally symmetrically arranged with each other.

The insulative housing 1 includes a body portion 1a and an insulator 1b integrated with the body portion 1a. The base portion 11 is formed by the rear ends of both the body portion 1a and the insulator 1b. The tongue portion 12 is formed by the extending forwardly portions (not labeled) of both the body portion 1a and the insulator 1b. The tongue portion 12 includes a pair of ear portions 121 projecting laterally from the both sides thereof. The rear end of the base portion 11 is provided with a pair of engagement portions 111 in an L-shape. The body portion 1a is provided with a plurality of terminal slots 122.

Each row of conductive terminals 2 include a plurality of grounding terminals G, a plurality of power terminals P, and a plurality of signal terminals (not labeled). Each conductive terminal 2 has a contacting section 21 exposed to a surface of the tongue portion 12, an embedding section 24 extending forwardly from the contacting section 21 and formed by thinning, a tail section 23 soldered to a printed circuit board (not shown), and a retaining section 22 connecting the contacting section 21 and the tail section 23.

The upper row of conductive terminals 2 include two upper grounding terminals G located on both sides thereof along the transverse direction, and two upper power terminals P and a plurality of upper signal terminals (not labeled) located on the inside of the two upper grounding terminals G. The retaining section 22 of each upper grounding terminal G is provided with a widened section or angled deflection 26. The contacting section 21 and the retaining section 22 of each upper power terminal P are an upright shape whose thickness is larger than the width. The tail sections 23 of the upper power terminals P and the tail sections 23 of the other terminals 2 of the two rows of conductive terminals 2 are arranged in a row in a coplanar way.

The lower row of conductive terminals 2 include two lower grounding terminals G located on both sides thereof along a transverse direction, and a plurality of lower signal terminals (not labeled) located on the inside of the two lower grounding terminals G. The retaining section 22 of each lower grounding terminal G is provided with a widened section 26. Two lower power terminals P of the lower row of conductive terminals 2 and two corresponding upper power terminals P are an integral block structure respectively. An upper power terminal P and a corresponding power terminal P form a power terminal P belonging to a common terminal. A cross section of each power terminal P is rectangular. A thickness of the contacting section 21 of each power terminal P is not less than a thickness of the tongue portion 12. The thickness of the contacting section 21 of each power terminal P is at least twice each thickness of the other terminals of conductive terminals 2.

The metallic shielding plate 3 includes a pair of flakes 31 which are provided separately. A rear end of each flake 31 is provided with a soldering leg 311 extending rearward and bending downwardly.

The metallic shell 5 includes a tubular main portion 51, and a plurality of grounding portions 52 protruding inwardly from the main portion 51. A pair of stopping portions 53 are provided on the inside of the main portion 51. The main portion 51 includes an upper wall 510, and a pair of side walls 513 on the both sides thereof. A rear edge of the main portion 51 is provided with a plurality of engagement slots 511 for opening rearward. The upper wall 510 is provided with a through hole 512. The rear side of the side walls 513 are provided with a retaining slot 54 penetrating with engagement slots 511.

The sealer 7 includes a pair of side securing portions 72, an upper securing portion 71 located between the pair of side securing portions 72, and a tuber 73 protruding upwardly from the upper securing portion 71.

Referring to FIGS. 1-11, the method of manufacturing the electrical connector 100 of the preferred embodiment of the instant invention includes the following steps:

The first step, two rows of conductive terminals 2 including the grounding terminals G and the power terminals P are punched out with a plurality of metal sheet (not shown). The power terminals P of the two rows of conductive terminals 2 are integrally formed into a block structure.

The second step, the upper row of conductive terminals 2 and the metallic shielding plate 3 are integrated with the body portion 1a. The embedding sections 24 of the upper row of conductive terminals 2 are retained in the body portion 1a.

The third step, the lower row of conductive terminals 2 are propped against the body portion 1a and are received in the plurality of terminal slots 122 of the body portion 1a respectively. Each flake 31 is clamped between an upper grounding terminal G and a corresponding lower grounding terminal G of the two rows of conductive terminals 2 and is in contact with the upper and lower grounding terminals G. Each flake 31 is separated from the power terminals P in the transverse direction.

The fourth step, the body portion 1a is integrated with the insulator 1b to form the insulative housing 1. The embedding sections 24 of the lower row of conductive terminals 2 are retained in the insulative housing 1. The two power terminals P are extending along a thickness direction of the tongue portion 12 in the tongue portion 12. The contacting sections 21 of the two power terminals P penetrate the metallic shielding plate 3 in the thickness direction. The thickness of the contacting section 21 of each power terminal P is not less than the thickness of the tongue portion 12 to be exposed to two corresponding surfaces of the tongue portion 12. An upper surface of the two power terminals P are exposed to a top surface of the tongue portion 12 so as to constitute the contacting sections 21 of upper power terminals P of the upper row of conductive terminals 2. A lower surface of the two power terminals P are exposed to a bottom surface of the tongue portion 12 so as to constitute the contacting sections 21 of lower power terminals P of the lower row of conductive terminals 2.

The fifth step, the metallic shell 5 is formed by metal injection molding. The terminal module 10 is assembled from rear to the inside of the metal shell 5. The base portion 11 of the terminal module 10 is attached to the stopping portions 53 of the metallic shell 5. The engagement portions 111 are mating with the engagement slots 511 respectively.

The sixth step, the sealer 7 is integrated with the terminal module 10 and the metallic shell 5 from the through hole 512 and is formed between the rear end of the body portion 1a and the metallic shell 5. The upper securing portion 71 of the sealer 7 is retaining in the inside of the upper wall 510 of the metallic shell 5. The tuber 73 of the sealer 7 is retaining in the through hole 512. The side securing portions 72 of the sealer 7 are retaining with the retaining slot 54 of the metallic shell 5 and are flush with the side walls 513 of the metallic shell 5.

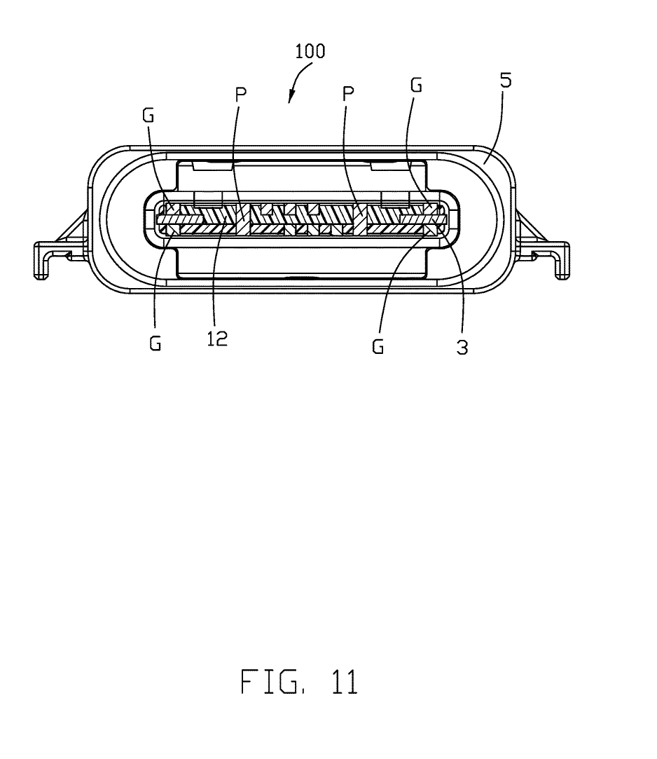

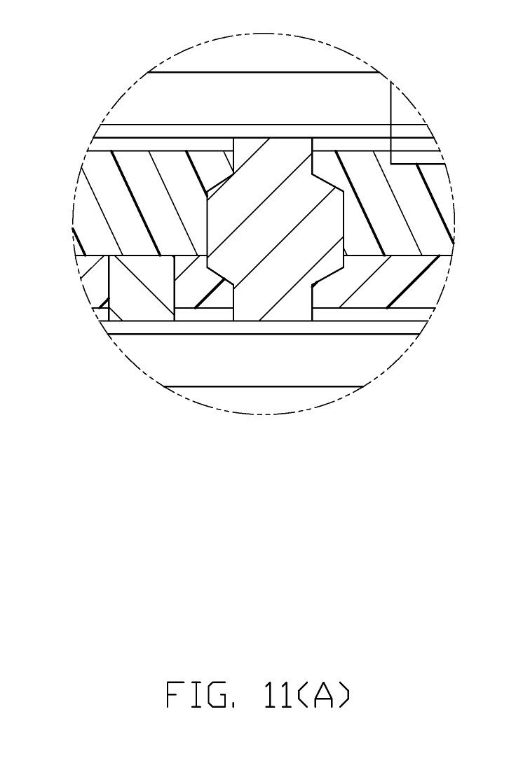

The upper power terminal P and the corresponding lower power terminal P are integrally formed into a block structure so that the power terminal P can have a maximum thickness in the case where the width thereof is the same as the other conductive terminals 2, thereby enhancing the heat dissipation area to facilitate passing through the large current. At the same time, the thickness of each power terminal P is at least twice the thickness of each grounding terminal G, so that metallic shielding plate 3 can be clamped between an upper grounding terminal G and a corresponding lower grounding terminal G to make the grounding effect better. One feature of the invention is to have the power terminal P forms an angled deflection or transversely offset section around the retaining section toward the neighboring grounding terminal G while away from the inner signal terminal in the transverse direction. In addition, the power terminal P also forms a surface-mount horizontal tail section during stamping from sheet metal rather than in a bending/forming procedure. Differently and oppositely, in the signal terminal or the grounding terminal G, the similar angled deflection or the retaining section is made via the stamping procedure while the tail section is formed via the bending/forming procedure. FIG. 11(A) shows another embodiment wherein the power terminal has a thinned structure in the thickness direction, i.e., the transverse direction, so as to have the some contacting section area exposed upon the surfaces of the tongue portion as the first embodiment while having an enlarged thickness in the embedded section for enhancement of the power delivery.

It is to be understood, however, that even though numerous characteristics and advantages of the present invention have been set forth in the foregoing description, together with details of the structure and function of the invention, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
a terminal module comprising an insulative housing provided with a base portion and a tongue portion, an upper row of conductive terminals and a lower row of conductive terminals retained to the insulative housing, and a metallic shielding plate clamped between the upper and lower rows of conductive terminals;
each row of conductive terminals comprising a plurality of grounding terminals located on both sides of the tongue portion along a transverse direction, and a plurality of power terminals located on the inside of the grounding terminals;
each conductive terminal having a contacting section exposed to a surface of the tongue portion, a tail section, and a retaining section connecting the contacting section and the tail section;
wherein an upper power terminal and a corresponding lower power terminal are of an integral block structure and extending along a thickness direction of the tongue portion in the tongue portion, a thickness of the contacting section of each power terminal is at least twice the thickness of the contacting section of each grounding terminal.

2. The electrical connector as claimed in claim 1, wherein said two rows of conductive terminals are diagonally symmetrically arranged with each other, each row of conductive terminals comprise two power terminals.

3. The electrical connector as claimed in claim 1, wherein said metallic shielding plate comprises a pair of flakes which are provided separately, each flake is clamped between an upper grounding terminal and a lower grounding terminal of the two rows of conductive terminals and is in contact with the upper and lower grounding terminals, the pair of flakes are separated from the power terminals in the transverse direction.

4. The electrical connector as claimed in claim 1, wherein said thickness of each power terminal is not less than a thickness of the tongue portion.

5. The electrical connector as claimed in claim 1, wherein said contacting section and said retaining section of each power terminal are an upright shape whose thickness is larger than the width, the tail sections of two rows of conductive terminals are arranged in a row in a coplanar way.

6. The electrical connector as claimed in claim 1, wherein said insulative housing comprises a body portion integrated with the upper row of conductive terminals, the body portion is provided with a plurality of terminal slots for receiving the lower row of conductive terminals, the insulative housing further comprises an insulator integrated with the body portion.

7. The electrical connector as claimed in claim 1, wherein said cross section of each power terminal is rectangular.

8. An electrical connector comprising:
a terminal module comprising an insulative housing provided with a base portion and a tongue portion, an upper row of conductive terminals and a lower row of conductive terminals retained to the insulative housing, and a metallic shielding plate residing between the upper and lower rows of conductive terminals;
each row of conductive terminals comprising a plurality of grounding terminals located on both sides of the tongue portion along a transverse direction, and a plurality of power terminals and a plurality of signal terminals located inside of the grounding terminals;
each conductive terminal having a contacting section exposed to a surface of the tongue portion, a tail section, and a retaining section connecting the contacting section and the tail section;
wherein an upper power terminal and a corresponding lower power terminal are an integral block structure and extending along a thickness direction of the tongue portion in the tongue portion, the contacting section of each power terminal penetrates the metallic shielding plate in the thickness direction, a thickness of the contacting section of each power terminal is not less than the thickness of the tongue portion so as to be exposed to two corresponding surfaces of the tongue portion.

9. The electrical connector as claimed in claim 8, wherein said width of the contacting section of each power terminal is not less than a width of the contacting section of each grounding terminal or each signal terminal.

10. The electrical connector as claimed in claim 8, wherein the grounding terminal in each row is discrete from the grounding terminal in the other row and cooperate with each other to commonly sandwich the shielding plate therebetwen in a vertical direction perpendicular to said transverse direction.

11. The electrical connector as claimed in claim 8, wherein a thickness of the contacting section of the power terminal is along the transverse direction while a thickness direction of the contact section of the signal terminal is along a vertical direction perpendicular to said transverse direction.

12. The electrical connector as claimed in claim 11, wherein said power terminal includes an angled deflection directing toward the neighboring grounding terminal, and the corresponding tail section extends horizontally.

13. The electrical connector as claimed in claim 12, wherein the neighboring grounding terminal includes a widened section extends toward the corresponding power terminal, and a thickness direction of the contacting section of the neighboring grounding terminal extends along the vertical direction.

14. The electrical connector as claimed in claim 13, wherein a cross-section of the power terminal in a vertical plane defined by the transverse direction and the vertical direction, includes two opposite thinned sections exposed upon two opposite surfaces of the tongue portion, and a thickened section embedded within the tongue portion between said two opposite thinned sections.

15. An electrical connector comprising:
an insulative housing including a base portion and a tongue portion forwardly extending from the base portion along a front-to-back direction, the tongue portion defining opposite upper and lower surfaces in a vertical direction perpendicular to said front-to-back direction;
a plurality of terminals in the housing and including power terminals, the grounding terminals and signal terminals, each of said terminals including a front contacting section, a rear tail section and a middle retaining section between the front contacting section and the rear tails section;
each of said terminals made from sheet metal by stamping and bending processes wherein a thickness of the power terminal is at least twice that of the signal terminal;
each of said terminals including a transversely offset section and a surface-mount horizontal tail section wherein in the power terminal the corresponding transversely offset section is made via forming and the corresponding horizontal tail section is made via stamping while in the signal terminal the corresponding transversely offset section is made via stamping and the corresponding horizontal tail section is made via bending.

16. The electrical connector as claimed in claim 15, wherein a thickness direction of the contacting section of the power terminal extends in a transverse direction perpendicular to both said front-to-back direction and the vertical direction while a thickness direction of the contacting section of the signal terminal extends in the vertical direction.

17. The electrical connector as claimed in claim 15, wherein the signal terminals are arranged in two rows with the corresponding contacting sections respectively exposed upon two opposite upper and lower surfaces of the tongue portion while the contacting section of each of the power terminals is exposed upon both said two opposite upper and lower surfaces of the tongue portion.

18. The electrical connector as claimed in claim 15, further including a pair of metallic flakes, wherein the grounding terminals are arranged in two rows intimately sandwiching the corresponding flakes in the vertical direction, respectively.

19. The electrical connector as claimed in claim 18, wherein the power terminal includes a widened section extending toward a transversely offset section of the neighboring power terminal in the transverse direction.

20. The electrical connector as claimed in claim 19, wherein a thickness direction of the grounding terminals extends in the vertical direction.
